(19) United States
(12) Patent Application Publication
(10) Pub. No.: US 2023/0396624 A1
(43) Pub. Date: Dec. 7, 2023

(54) EXTENDING BORDER GATEWAY PROTOCOL (BGP) FLOWSPEC ORIGINATION AUTHORIZATION USING PATH ATTRIBUTES

(71) Applicant: HUAWEI TECHNOLOGIES CO., LTD., Shenzhen (CN)

(72) Inventors: Yingzhen Qu, Plano, TX (US); Alvaro Enrique Retana, Plano, TX (US)

(21) Appl. No.: 18/454,448

(22) Filed: Aug. 23, 2023

Related U.S. Application Data
(63) Continuation of application No. PCT/US2021/038878, filed on Jun. 24, 2021.

(51) Int. Cl. H04L 9/40

(52) U.S. Cl. CPC H04L 63/101

(57) ABSTRACT

A method performed by a first node of a first autonomous system (AS) for verifying that a second node of a second AS is authorized to issue a Border Gateway Protocol (BGP) flow specification (FlowSpec). The first node receives from a third node of third AS a first BGP update message that includes a FlowSpec AS authorization list indicating autonomous systems (ASes) that are authorized to issue a FlowSpec for the prefix of the third AS. The first node receives, from the second node of the second AS, a second BGP update message that includes a FlowSpec associated with the prefix of the third AS. The first node determines whether the FlowSpec AS authorization list includes the second AS. The network node rejects the FlowSpec when the FlowSpec AS authorization list does not include the second AS.

### CROSS-REFERENCE TO RELATED APPLICATIONS

This application is a continuation of International Patent Application No. PCT/US2021/038878 filed on Jun. 24, 2021, by Futurewei Technologies, Inc., and titled “Extending Border Gateway Protocol (BGP) Flowspec Origination Authorization Using Path Attributes,” which is hereby incorporated by reference in its entirety.

### TECHNICAL FIELD

The present disclosure is related to network communications, and specifically to various systems and methods for extending BGP flow specification (FlowSpec) origination authorization using path attributes.

### BACKGROUND

Modem Internet Protocol (IP) routers have the capability to forward traffic and to classify, shape, rate limit, filter, or redirect packets based on administratively defined policies.

### SUMMARY

A first aspect relates to a method performed by a first node/network node of a first/receiving autonomous system (AS) for verifying that a second/sending AS is authorized to issue a BGP FlowSpec. The method includes the first node receiving from a third node of a third AS, a first BGP update message that includes a FlowSpec AS authorization list indicating autonomous systems (ASes) that are authorized to issue a FlowSpec for the prefix of the third AS. The first node receives a second BGP update message from the second node of the second AS. The second BGP update message includes a FlowSpec associated with the prefix of the third AS. The first node determines that the second AS is authorized to issue the FlowSpec when the FlowSpec AS authorization list includes the second AS. The first node determines whether the second AS is a closest neighboring AS to the first AS along a best-match unicast route for a destination prefix. The first node accepts the FlowSpec when the second AS is the closest neighboring AS to the first AS along the best-match unicast route for the destination prefix and the second AS is authorized to issue the FlowSpec. The first node performs a flow traffic action associated with the FlowSpec when the first node receives traffic that matches a set of traffic parameters specified by the FlowSpec.

In a first implementation form of the method according to the first aspect, the first node rejects the FlowSpec when the FlowSpec AS authorization list does not include the second AS.

In a second implementation form of the first aspect as such or any preceding implementation form of the first aspect, the network node rejects the FlowSpec when the second AS is not the closest neighboring AS to the first AS along the best-match unicast route for the destination prefix.

In a third implementation form of the first aspect as such or any preceding implementation form of the first aspect, the FlowSpec AS authorization list is specified in a BGP FlowSpec trust list path attribute included in a path attributes portion of the first BGP update message.

In a fourth implementation form of the first aspect as such or any preceding implementation form of the first aspect, the BGP FlowSpec trust list path attribute is an optional transitive BGP path attribute.

In a fifth implementation form of the first aspect as such or any preceding implementation form of the first aspect, the BGP FlowSpec trust list path attribute is encoded using a Flowspec Trust List Type-Length-Value (TLV) encoding format, and wherein a value field of the Flowspec Trust List TLV specifies a list of autonomous systems (ASes) that are authorized to issue the FlowSpec.

In a sixth implementation form of the first aspect as such or any preceding implementation form of the first aspect, wherein determining that the second AS is the closest neighboring AS to the first AS along the best-match unicast route for the destination prefix includes using a secured AS path list that is part of a routing table of the network node.

In a seventh implementation form of the first aspect as such or any preceding implementation form of the first aspect, the method includes obtaining the secured AS path list using BGP security (BGPsec).

A second aspect relates to a network node of a first AS for verifying that a second AS is authorized to issue a BGP FlowSpec. The network node includes a memory storing instructions; a processor coupled to the memory, the processor configured to execute the instructions to cause the network node to receive a first BGP update message from a third AS. The first BGP update message includes a FlowSpec AS authorization list indicating ASes that are authorized to issue a FlowSpec for the prefix of the third AS. The processor further executes the instructions to cause the network node to receive a second BGP update message from the second AS. The second BGP update message includes a FlowSpec associated with the prefix of the third AS. The processor executes the instructions to determine that the second AS is authorized to issue the FlowSpec when the FlowSpec AS authorization list includes the second AS. The processor executes the instructions to determine whether the second AS is a closest neighboring AS to the first AS along a best-match unicast route for a destination prefix. The processor executes the instructions to accept the FlowSpec when the second AS is the closest neighboring AS to the first AS along the best-match unicast route for the destination prefix and the second AS is authorized to issue the FlowSpec. The processor executes the instructions to perform a flow traffic action associated with the FlowSpec when the network node receives traffic that matches a set of traffic parameters specified by the FlowSpec.

In a first implementation form of the network node according to the second aspect, the processor executes the instructions to reject the FlowSpec when the FlowSpec AS authorization list does not include the second AS.

In a second implementation form of the second aspect as such or any preceding implementation form of the second aspect, the processor executes the instructions to reject the FlowSpec when the second AS is not the closest neighboring AS to the first AS along the best-match unicast route for the destination prefix.

In a third implementation form of the second aspect as such or any preceding implementation form of the second aspect, the FlowSpec AS authorization list is specified in a BGP FlowSpec trust list path attribute included in a path attributes portion of the first BGP update message.

In a fourth implementation form of the second aspect as such or any preceding implementation form of the second aspect, the BGP FlowSpec trust list path attribute is an optional transitive BGP path attribute.

In a fifth implementation form of the second aspect as such or any preceding implementation form of the second aspect, the BGP FlowSpec trust list path attribute is encoded using a Flowspec Trust List TLV encoding format, and wherein a value field of the Flowspec Trust List TLV specifies a list of ASes that are authorized to issue the FlowSpec.

In a sixth implementation form of the second aspect as such or any preceding implementation form of the second aspect, the processor executes the instructions to determine that the second AS is the closest neighboring AS to the first AS along the best-match unicast route for the destination prefix using a secured AS path list that is part of a routing table of the network node.

In a seventh implementation form of the second aspect as such or any preceding implementation form of the second aspect, the processor executes the instructions to obtain the secured AS path list using BGPsec.

A third aspect relates to a method performed by a network node of a first AS for verifying that a second AS is authorized to issue a BGP FlowSpec. The network node receives a first BGP update message from a third AS. The first BGP update message includes a FlowSpec AS authorization list indicating ASes that are authorized to issue a FlowSpec for the prefix of the third AS. The network node receives a second BGP update message from second node of the second AS. The second BGP update message includes a FlowSpec associated with the prefix of the third AS. The network node determines whether the FlowSpec AS authorization list includes the second AS. The network node rejects the FlowSpec when the FlowSpec AS authorization list does not include the second AS.

In a first implementation form according to the third aspect, the FlowSpec AS authorization list is specified in a BGP FlowSpec trust list path attribute included in a path attributes portion of the first BGP update message.

For the purpose of clarity, any one of the foregoing implementation forms may be combined with any one or more of the other foregoing implementations to create a new embodiment within the scope of the present disclosure. These embodiments and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram illustrating a communication network in accordance with an embodiment of the present disclosure.

FIG. 2 is a schematic diagram illustrating a malicious rerouting of a BGP update message.

FIG. 3 is a schematic diagram illustrating a BGP update message in accordance with an embodiment of the present disclosure.

FIG. 4 is a schematic diagram illustrating a FlowSpec trust list in accordance with an embodiment of the present disclosure.

FIG. 5 is a schematic diagram illustrating a Flowspec Trust List TLV in accordance with an embodiment of the present disclosure.

FIG. 6 is a flowchart illustrating a process for validating a Flowspec in accordance with an embodiment of the present disclosure.

FIG. 7 is a schematic diagram illustrating a system in accordance with an embodiment of the present disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

BGP is a standardized exterior gateway protocol designed to exchange routing and reachability information between ASes on the Internet (i.e., an inter-AS routing protocol). The primary function of a BGP speaking system is to exchange Network Layer Reachability Information (NLRI) with other BGP systems. NLRI includes information on the list of ASes that reachability information traverses. BGP FlowSpec is a BGP extension that includes a new NLRI. The new NLRI collects 12 types of Layer 3 and Layer 4 details that are used to define a Flowspec. The Flowspec can be distributed to border or edge routers of a network to filter traffic that matches the criteria specified in the Flowspec (e.g., to prevent or stop a distributed denial-of-service (DDoS) attack). As will described herein, while BGP Flowspec can be used to prevent malicious attacks, BGP Flowspec can also be used to maliciously filter authorized/normal traffic when originated by an unauthorized AS.

The disclosed embodiments provide several technical improvements over existing techniques including extending BGP to include a BGP FlowSpec trust list path attribute that carries a FlowSpec AS authorization list indicating ASes that are authorized to send a Flowspec for a particular prefix. The disclosed embodiments reduce or eliminate the probability of BGP Flowspec being accepted when originated by an unauthorized AS. Thus, the disclosed embodiments increase network security by reducing malicious activities from occurring on the network.

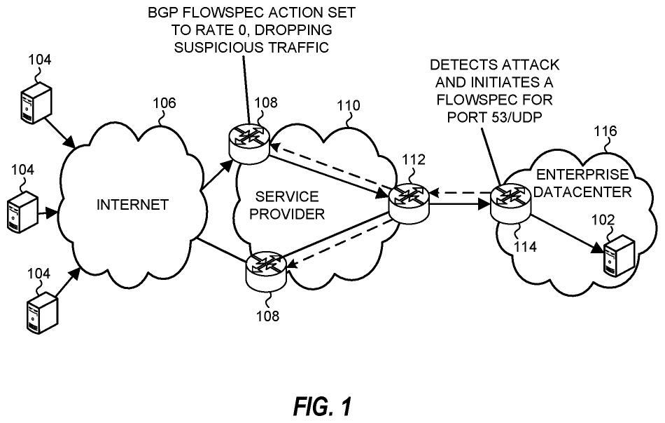

FIG. 1 is a schematic diagram illustrating a communication network in accordance with an embodiment of the present disclosure. In the depicted embodiment, a server 102 located in an enterprise network 116 provides services to one or more end-user devices 104. The one or more end-user devices 104 communicate with the server 102 via the Internet 106, which in turn is connected to border routers 108 (also known as border routers) of a service provider network 110 (as indicated by the solid arrows). The service provider network 110 provides Internet access to the devices on the enterprise network 116. The communications data from the end-user devices 104 are routed through the service provider network 110 to a border router 112. The border router 112 of the service provider network communicates with a border router 114 of the enterprise network 116. The border router 114 routes the communications to the server 102.

In FIG. 1, when the border router 114 of the enterprise network 116 detects a denial-of-service attack targeted at the server 102 (e.g., on port 53/UDP of the server 102), the border router 114 initiates a flow specification (Flowspec) or BGP Flowspec for port 53/UDP of the server 102. A Flowspec is an n-tuple (a sequence or ordered list of n elements, where n is a non-negative integer) consisting of several matching criteria that can be applied to IP traffic. The Flowspec can be distributed as BGP NLRI in a BGP update message. A BGP update message is used for exchanging routing information between BGP peers (e.g., to advertise feasible routes that share common path attributes to a peer, or to withdraw multiple unfeasible routes from service). A given IP packet is said to match the defined flow if the IP packet matches all the specified criteria in the Flowspec (e.g., source prefix, destination prefix, IP Protocol, source or destination ports, L4 parameters, and packet specifics such as length, fragment and so on). The border router 114 transmits the Flowspec to the border router 112 of the service provider network 110 (as indicated by the dashed arrows). The border router 112 then forwards the Flowspec to the border routers 108 so that the DDoS attack can be stopped before entering the service provider network 110. The FlowSpec allows rapid deployment and propagation of filtering and policing functionality to mitigate the effects of the DDoS attack. For example, the FlowSpec allows for a dynamic installation of an action at the border routers 108 to either drop the traffic, inject the traffic in a different virtual routing and forwarding (VRF) instance for analysis, or allow the traffic, but police the traffic at a specific defined rate. To accomplish this, the border routers 108 create an access-list (ACL) with class-map and policy-map to implement the advertised rule in the Flowspec. An ACL will filter traffic coming in or out of a particular network interface. The border routers 108 compare each packet to the criteria of the access list and will either be permitted (or permitted with limitations) or dropped. A class-map is an entity in a router that classifies network traffic (i.e., defines traffic classes based on various match criteria). A policy map references the class maps and identifies a series of actions to perform based on the traffic match criteria.

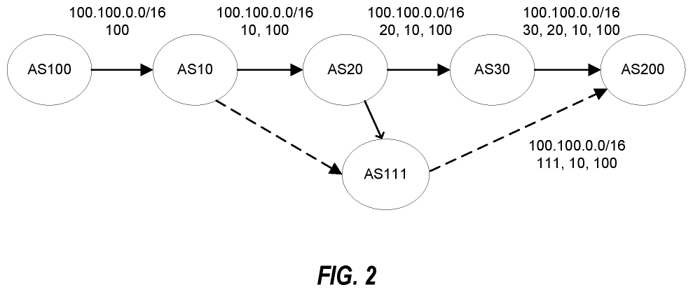

FIG. 2 is a schematic diagram illustrating a malicious rerouting of a BGP update message. In the depicted embodiment, a source AS (e.g., AS100) attempts to send the prefixes under its control to a destination AS (e.g., AS200) along an AS path AS1004AS104AS204AS304AS200. An AS is a collection of connected IP routing prefixes under the control of one or more network operators on behalf of a single administrative entity or domain. A prefix is a network address followed by a subnet mask. For example, in FIG. 2, AS100 sends the prefixes of AS100 (e.g., 100.100.0.0/16) in a NLRI field of a BGP update message to AS10. The prefixes indicate the range of IP addresses under the control of AS100. As will be further described, the NLRI field of a BGP update message can also include a Flowspec. The AS100 also appends an AS number of AS100 (i.e., 100) as part of a AS_PATH attribute in the BGP update message. The AS_PATH attribute is a mandatory attribute that uses a sequence of AS numbers to describe the inter-AS path, or AS-level route, to the destination specified by the NLRI (e.g., AS200 in FIG. 2). Simply put, the AS_PATH attribute records all the ASes that a route passes through from the source AS100 to the destination AS200. For instance, in FIG. 2, when AS10 forwards the prefixes of AS100 (100.100.0.0/16) to AS20, AS10 prepends AS number 10 to the AS_PATH attribute in the BGP update message. The AS_PATH attribute now contains AS numbers 10, 100 as shown in FIG. 2. The BGP update message hops from AS to AS until the BGP update message reaches the AS that contains the destination IP address (i.e., AS200). Along the way, AS20 prepends AS number 20 to the AS_PATH attribute (20, 10, 100) in the BGP update message when the AS20 forwards the BGP update message to AS30. AS30 prepends AS number 30 to the AS_PATH attribute (30, 20, 10, 100) in the BGP update message when the AS30 forwards the BGP update message to the destination AS200. The AS_PATH attribute, along with other attributes, can then be used to identify the best path to a destination.

Currently, in the absence of explicit configuration, an AS that receives the BGP update message containing a Flowspec NLRI must validate the Flowspec NLRI. The Flowspec NLRI is considered feasible when and only when all of the three following conditions are true: (1) a destination prefix component is embedded in the Flowspec; (2) the originator of the Flowspec matches the originator of the best-match unicast route for the destination prefix embedded in the Flowspec (i.e., the unicast route with the longest possible prefix length covering the destination prefix embedded in the Flowspec), and (3) there are no “more-specific” unicast routes, when compared with the flow destination prefix, that have been received from a different neighboring AS than the best-match unicast route. The underlying concept is that the neighboring AS that advertises the best unicast route for a destination is allowed to advertise Flowspec information that conveys a destination prefix that is more or equally specific. Thus, if there are no “more-specific” unicast routes received from a different neighboring AS, which would be affected by that Flowspec, the Flowspec is validated successfully.

Additionally, the BGP Flowspec implementation must also enforce that the AS in the left-most position of the AS_PATH attribute of a Flowspec route received via the External Border Gateway Protocol (eBGP) matches the AS in the left-most position of the AS_PATH attribute of the best-match unicast route for the destination prefix embedded in the Flowspec NLRI. The AS in the left-most position of the AS_PATH attribute means the AS that was last added to the AS_SEQUENCE. The AS_SEQUENCE is a component of the AS_PATH attribute. The AS_SEQUENCE is an ordered set of ASes indicating a route that the BGP update message has traversed. The above requirement enables the exchange of BGP Flowspec NLRIs at Internet exchanges with BGP route servers while at the same time, for security reasons, prevents an eBGP peer from advertising an inter-domain Flow Specification for a destination prefix that it does not provide reachability information for. Comparing only the last AS added is sufficient for eBGP learned Flowspec NLRIs. Requiring a full AS_PATH match would limit origination of inter-domain Flowspec to the origin AS of the best-match unicast route for the destination prefix embedded in the Flow Specification only. As such, a full AS_PATH validity check may prevent transit ASes from originating inter-domain Flowspecs, which is not desirable.

However, as shown in FIG. 2, a malicious attack can occur where AS111 hijacks/intercepts the BGP update message containing the Flowspec NLRI from AS20. AS111 can then append the AS_PATH attribute with the AS number of AS111 (e.g., 111, 10, 100) and transmit the BGP update message to AS200. The Flowspec NLRI from AS111 will pass the above validation process because AS111 is now the best unicast path to reach network 100.100.0.0/16. AS111 can send a malicious Flowspec to AS200 requesting that AS200 drop/rate limit or redirect traffic sent to 100.100.0.0/16. Additionally, even though AS30 is in the path and is a valid node, AS30 can also send a Flowspec and request AS200 drop traffic to AS100 without AS100 knowing or agreeing that AS30 perform this request.

To reduce or eliminate the probability of a node in an unauthorized AS originates a BGP Flowspec, the disclosed embodiments provide various systems and methods for extending BGP Flowspec origination authorization using path attributes. Path attributes are characteristics, features, or qualities of a path that are included in a BGP update message. The path attributes can be used to determine a best routing path.

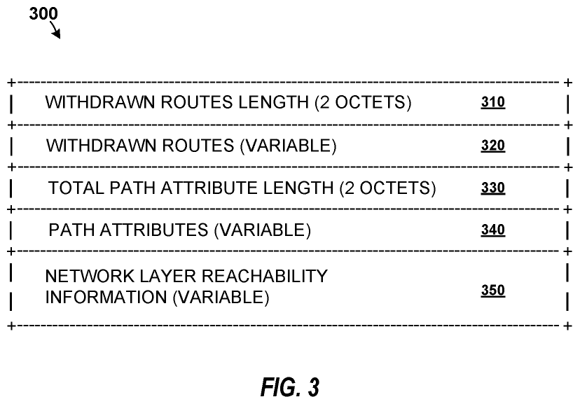

FIG. 3 is a schematic diagram illustrating fields of a BGP update message 300 in accordance with an embodiment of the present disclosure. The depicted fields of the BGP update message 300 advertise any feasible routes, withdraw previously advertised routes, or both. The BGP update message 300 includes the NLRI that includes the prefix and associated BGP path attributes when advertising prefixes. Withdrawn NLRIs include only the prefix. The BGP update message 300 also includes a fixed-size BGP header (not shown) that includes the total length of the BGP update message 300, including the header in octets. The fixed-size BGP header also includes a type field containing a type code to indicate that the message is a BGP update message (type code 2 indicates the message is a BGP update message).

The BGP update message 300 includes an unfeasible routes section that includes a 2-byte withdrawn routes length field 310 and a variable-size withdrawn routes field 320. The BGP update message 300 also include a path attributes section that includes a 2-byte total path attribute length field 330 and a variable-size path attributes field 340. The BGP update message 300 also includes a variable-size network layer reachability information (NLRI) field 350.

The withdrawn routes length field 310 indicates the total length of the withdrawn routes field 320 in bytes. Withdrawn routes are routes that are down or no longer reachable. When there are no withdrawn routes, the withdrawn routes length field 310 is set to zero. The withdrawn routes field 320 contains all the prefixes that should be removed from the BGP routing table.

The total path attribute length field 330 indicates the total length of the path attributes field 340. AS path attributes are used to provide route metrics. Path attributes allow BGP to determine the best path. The path attributes are stored in Type, Length, Value (TLV)-format. Each of the path attributes can also have an attribute flag that informs the BGP router about how to treat the attribute.

The path attributes field 340 indicates the BGP attributes for the prefixes. All BGP path attributes fall into one of four main categories: well-known mandatory path attributes, well-known discretionary path attributes, optional transitive path attributes, and optional non-transitive path attributes. Well-known means that all routers must recognize this path attribute. Optional means that the BGP implementation on the device does not have to recognize that path attribute at all. Mandatory means that the update must contain that attribute. If the attribute does not exist, a notification error message will result, and the peering will be torn down. Discretionary, of course, would mean the attribute does not have to be in the update. Transitive means the BGP routers need to pass that path attribute on toward its next neighbor. Non-transitive means the BGP routers can just ignore that attribute value.

Thus, well-known mandatory path attributes must be recognized by all BGP routers and must be included in every BGP update message. Examples of well-known mandatory path attributes include ORIGIN, AS_PATH, and NEXT_HOP path attributes. Routing information errors occur without these attributes. Well-known discretionary path attributes can be recognized by all BGP routers and can be included in every update message as needed. Examples of well-known discretionary path attributes include LOCAL_PREF and ATOMIC_AGGREGATE path attributes. Optional transitive path attributes are transitive attribute between ASs. A BGP router not supporting this attribute can still receive routes with this attribute and advertise them to other peers. An example of an optional transitive path attributes is the COMMUNITY path attribute. For optional non-transitive path attributes, when a BGP router does not support this attribute, the BGP router will not advertise routes with this attribute. Examples of optional non-transitive path attributes include MULTI_EXIT_DISC (MED), ORIGINATOR_ID, and CLUSTER_LIST path attributes.

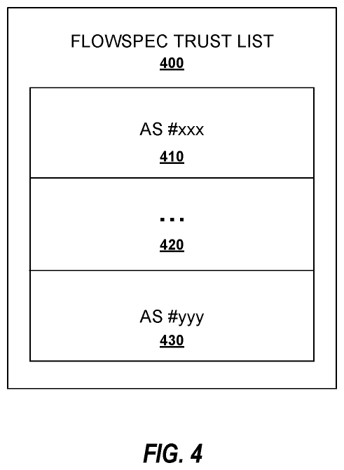

FIG. 4 is a schematic diagram illustrating a FlowSpec trust list 400 in accordance with an embodiment of the present disclosure. The FlowSpec trust list 400 contains a list of ASes allowed to send a BGP Flowspec for a prefix of an AS. For example, the FlowSpec trust list 400 can include AS #xxx 410 (where #xxx is an AS number), one or more ASes (represented by . . . 420), and AS #yyy 430 (where #yyy is another AS number). A node of the AS generates the FlowSpec trust list 400 and advertises the FlowSpec trust list 400 in a BGP update message. For instance, in FIG. 2, AS100 is the owner of prefix 100.100.0.0/16. A node of the AS100 can generate the FlowSpec trust list 400 and specify the ASes allowed to send BGP Flowspec for the prefix 100.100.0.0/16. The node of the AS100 includes the FlowSpec trust list 400 in a BGP update message when the node of the AS100 sends a route update for prefix 100.100.0.0/16. Thus, the prefix owner decides which ASes can issue a Flowspec for the prefix under its control. For example, in FIG. 2, a first node of AS20 can send a Flowspec to a second node of AS30 and request that the second node of AS30 redirect or drop traffic to 100.100.0.0/16. In accordance with the disclosed embodiments, the second node of AS30 verifies that first node of AS20 is authorized to send the Flowspec associated with the prefix of AS 100 by checking the FlowSpec trust list 400 that the second node received with the route update of 100.100.0.0./16 from AS100.

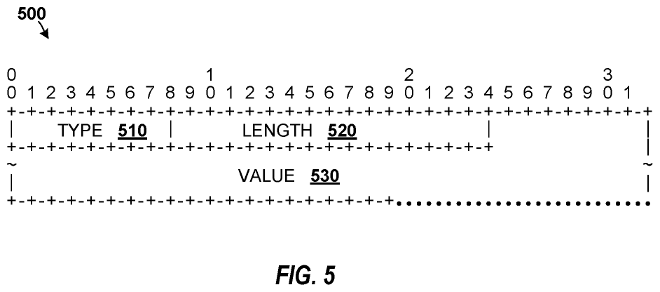

FIG. 5 is a schematic diagram illustrating a Flowspec Trust List TLV 500 in accordance with an embodiment of the present disclosure. The Flowspec Trust List TLV 500 can be used to encode the FlowSpec trust list 400. In an embodiment, the encoded FlowSpec trust list is called a BGP FlowSpec trust list path attribute. The BGP FlowSpec trust list path attribute can then be included in the path attributes field 340 of the BGP update message 300 in FIG. 3. In an embodiment, the BGP FlowSpec trust list path attribute is an optional transitive BGP path attribute. As stated above, transitive means the BGP routers need to pass the BGP FlowSpec trust list path attribute on toward its next neighbor. Optional means a BGP router that does not support the BGP FlowSpec trust list path attribute can still receive routes with the BGP FlowSpec trust list path attribute and advertise the routes to other peers.

The Flowspec Trust List TLV 500 includes a Type field 510, a Length field 520, and a Value field 530. The Type field 510 has a size of a single octet or eight bits. The Type field 510 specifies an attribute type code to indicate that the TLV is a Flowspec Trust List TLV 500. The Internet Assigned Numbers Authority (IANA) will assign the attribute type code (e.g., type 1) for the Type field 510. The Length field 520 has a size of two octets or 16 bits. The Length field 520 indicates the size of the Value field 530 (typically in bytes). The Value field 530 contains zero or more octets specifying the list of allowed ASes, as depicted in FIG. 4, that could send a BGP Flowspec for the prefix in the BGP update message. In an embodiment, each AS number is encoded as a four-octet number.

In an embodiment, the Flowspec Trust List TLV 500 is not encrypted (i.e., basic form). Alternatively, in some embodiments the Flowspec Trust List TLV 500 is encrypted with the Resource Public Key Infrastructure (RPKI) private key of the owner AS (i.e., the AS generating the Flowspec Trust List TLV 500).

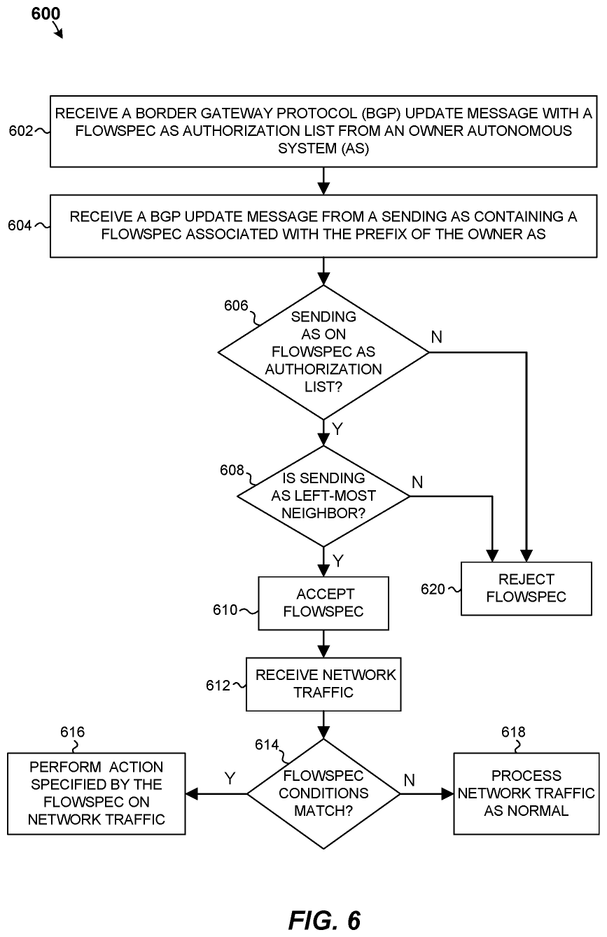

FIG. 6 is a flowchart illustrating a process 600 for validating a Flowspec in accordance with an embodiment of the present disclosure. The process 600 can be performed by a network node (e.g., BGP router) of a first AS for verifying that a second AS is authorized to issue the FlowSpec. The network node receives, at step 602, a BGP update message originated by a third AS. The BGP update message includes a FlowSpec AS authorization list that indicates the ASes that are authorized to issue a FlowSpec for the prefix under the control of the third AS (i.e., the owner AS). As described above, the FlowSpec AS authorization list can be encoded as a path attribute in the BGP update message. The network node stores the FlowSpec AS authorization list in memory.

At step 604, the network node receives a second a BGP update message from second AS or sending AS. The second BGP update message include a Flowspec associated with the prefix of the owner AS. The network node, at step 606, determines whether the Flowspec AS authorization List includes the sending AS. If the Flowspec AS authorization List does not include the sending AS, the network node, at step 620, rejects the BGP Flowspec in the BGP update message (i.e., does not filter traffic according to the received Flowspec).

At step 608, the network node determines whether the second/sending AS is the left-most or closest neighboring AS to the first AS along the best-match unicast route for the destination prefix. In an embodiment, the network node determines whether the sending AS is both in the left-most position of the AS_PATH attribute of a Flowspec route received via the eBGP and in the left-most position of the AS_PATH attribute of the best-match unicast route for the destination prefix embedded in the Flowspec NLRI. As stated above, the AS in the left-most position of the AS_PATH attribute is the AS that was last added to the AS_PATH attribute, which indicates the AS that last transmitted the BGP update message. In an embodiment, the first AS determines whether the second/sending AS is the closest neighboring AS to the first AS along the best-match unicast route for the destination prefix using a secured AS path list that is part of a routing table of the first AS. In an embodiment, each BGP router or node on the secured AS path list is encrypted to ensure the validity of the secured AS path list. For example, in an embodiment, the first node obtains the secured AS path list using BGP Security (BGPsec). BGPsec is an extension to BGP that provides to receivers of valid BGPsec update messages cryptographic verification of the routes they advertise. BGPsec can be used to verify that the second/sending AS is in the path to the prefix received. BGPsec replaces the BGP AS_PATH attribute with a new BGPsec_Path attribute. In an embodiment, the BGPsec_Path attribute is an optional non-transitive BGP path attribute. For example, any AS that supports BGPsec has a private key associated with a RPKI router certificate. An originating AS can generate a signature using the RPKI private key of the originating AS. The signature of the originating AS is then included in the BGPsec_Path attribute of a BGPsec update message advertised by the originating AS. Any BGP router along the path that forwards the BGPsec update message adds its signature using its private key to the BGPsec_Path attribute of the BGPsec update message. An AS that receives the BGPsec update message uses the public keys of the BGP routers to verify the signatures. The digital signatures provide confidence that every AS on the path of ASes listed in the BGPsec update message has explicitly authorized the advertisement of the route. Thus, BGPsec can provide full path validation and protect against the man in the middle attack. In an embodiment, to verify that a receiving BGP router has this security capability, BGP capability can be negotiated between BGP routers prior to sending a FlowSpec AS authorization list. When the second AS is not the closest neighboring AS to the first AS along the best-match unicast route for the destination prefix, the network node, at step 620, rejects the BGP Flowspec in the BGP update message. When the second AS is both the closest neighboring AS to the first AS along the best-match unicast route for the destination prefix and is in the Flowspec AS authorization List, the network node, at step 610, accepts the BGP Flowspec in the BGP update message.

At step 612, the network node receives network traffic. The network node determines, at step 614, whether the network traffic matches the criteria of the Flowspec specified in the BGP update message. At step 616, when the network traffic matches the criteria of the Flowspec, the network node performs the action associated with the Flowspec on network traffic (e.g., drops the packet). In an embodiment, the action associated with the Flowspec is specified in the BGP update message using a BGP Extended Community encoding format. Community information is included as a path attribute in BGP update message.

When the network traffic does not match the criteria of the Flowspec, the network node, at step 618, processes the network traffic as normal (e.g., forwarding the packets to the destination node).

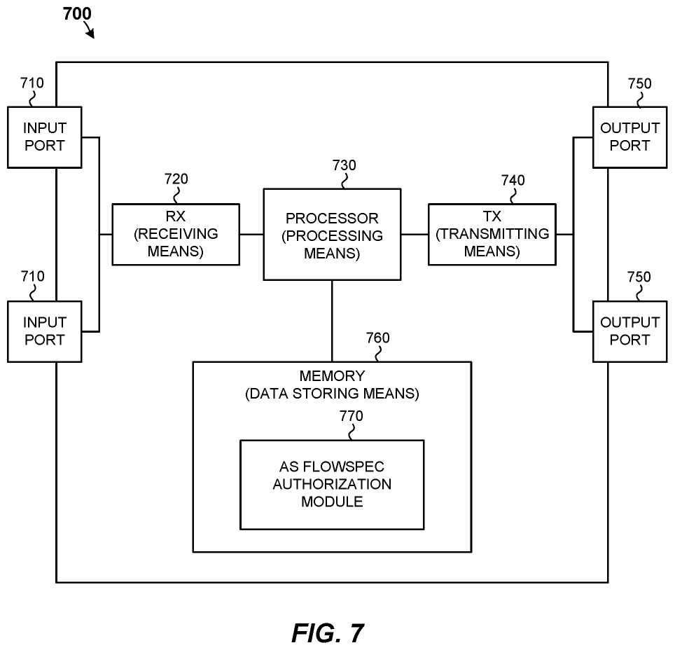

FIG. 7 is a schematic diagram illustrating a system 700 in accordance with an embodiment of the present disclosure. The system 700 may be used to implement various embodiments of a network node or BGP router as disclosed herein. The system 700 includes a receiver unit (RX) 720 or receiving means for receiving data via one or more input ports 710. The system 700 also includes a transmitter unit (TX) 740 or transmitting means for transmitting or forwarding data out of one or more output ports 750. In some embodiments, the RX 720 and the TX 740 may be combined into a single transceiver unit. Additionally, an input 710 and output port 750 may be combined into a bidirectional port.

The system 700 includes a memory 760 or data storing means for storing the instructions and various data. The memory 760 can be any type of or combination of memory components capable of storing data and/or instructions. For example, the memory 760 can include volatile and/or non-volatile memory such as read-only memory (ROM), random access memory (RAM), ternary content-addressable memory (TCAM), and/or static random-access memory (SRAM). The memory 760 can also include one or more disks, tape drives, and solid-state drives. In some embodiments, the memory 760 can be used as an over-flow data storage device or buffer to store programs when such programs are selected for execution, and to store instructions and data that are read during program execution.

The system 700 has one or more processors 730 or other processing means to process instructions. In some embodiments, the processor 730 may be a central processing unit (CPU) chip having one or more processing cores, a field-programmable gate array (FPGA), an application specific integrated circuit (ASIC), and/or a digital signal processor (DSP). The processor 730 is communicatively coupled via a system bus with the ingress ports 710, RX 720, TX 740, egress ports 750, and memory 760. The processor 730 can be configured to execute instructions stored in the memory 760. Thus, the processor 730 provides a means for performing any computational, comparison, determination, initiation, or configuration steps, or any other action, corresponding to the claims or disclosure when the appropriate instruction is executed by the processor. In some embodiments, the memory 760 can be memory that is integrated with the processor 730.

In one embodiment, the memory 760 stores an AS Flowspec authorization module 770. The AS Flowspec authorization module 770 includes data and executable instructions for implementing the disclosed embodiments. For instance, the AS Flowspec authorization module 770 can include instructions for implementing the method described in FIG. 6. The inclusion of the AS Flowspec authorization module 770 provides a technical improvement to the functionality of the system 700 by enabling the system 700 to ensure the validity of a Flowspec.

In some embodiments, the system 700 may include additional modules for performing any one of or combination of steps described in the embodiments. A module may include a particular set of functions, software instructions, or circuitry that is configured to perform a specific task. Further, any of the additional or alternative embodiments or aspects of the method, as shown in any of the figures or recited in any of the claims, are also contemplated to include similar modules.

Certain embodiments may be implemented as a system, an apparatus, a method, and/or a computer program product. The computer program product may include a computer readable storage medium (or media) having computer readable program instructions thereon for causing a processor to carry out aspects of the present disclosure. The computer readable storage medium may be a tangible device that can retain and store instructions for use by an instruction execution device.

While several embodiments have been provided in the present disclosure, the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method performed by a first node of a first autonomous system (AS) for verifying that a second node of a second AS is authorized to issue a Border Gateway Protocol (BGP) flow specification (FlowSpec), the method comprising:
receiving, from a third node of a third AS, a first BGP update message comprising a FlowSpec AS authorization list indicating autonomous systems (ASes) that are authorized to issue FlowSpecs for a prefix of the third AS;
receiving, from the second node of the second AS, a second BGP update message comprising a FlowSpec associated with the prefix of the third AS;
determining that the second AS is authorized to issue the FlowSpec when the FlowSpec AS authorization list includes the second AS;
determining whether the second AS is a closest neighboring AS to the first AS along a best-match unicast route for a destination prefix;
accepting the FlowSpec when the second AS is the closest neighboring AS to the first AS along the best-match unicast route for the destination prefix and the second AS is authorized to issue the FlowSpec; and
performing a traffic flow action associated with the FlowSpec when the first node receives traffic that matches a set of traffic parameters specified by the FlowSpec.

2. The method according to claim 1, further comprising rejecting the FlowSpec when the FlowSpec AS authorization list does not include the second AS.

3. The method of claim 1, further comprising rejecting the FlowSpec when the second AS is not the closest neighboring AS to the first AS along the best-match unicast route for a destination prefix.

4. The method of claim 1, wherein the FlowSpec AS authorization list is specified in a BGP FlowSpec trust list path attribute included in a path attributes portion of the first BGP update message.

5. The method according to claim 4, wherein the BGP FlowSpec trust list path attribute is an optional transitive BGP path attribute.

6. The method of claim 4, wherein the BGP FlowSpec trust list path attribute is encoded using a Flowspec Trust List Type-Length-Value (TLV) encoding format, and wherein a value field of the Flowspec Trust List TLV list the ASes in the FlowSpec AS authorization list.

7. The method of claim 1, wherein determining whether the second AS is the closest neighboring AS to the first AS along the best-match unicast route for the destination prefix comprises determining whether the second AS is both in a left-most position of an AS_PATH attribute of a Flowspec route received via an External Border Gateway Protocol (eBGP) and in the left-most position of the AS_PATH attribute of the best-match unicast route for the destination prefix embedded in the Flowspec.

8. The method of claim 1, wherein determining whether the second AS is closest neighboring AS to the first AS along the best-match unicast route for the destination prefix comprises using a secured AS path list that is part of a routing table of the first node.

9. The method according to claim 8, further comprising obtaining the secured AS path list using BGP security (BGPsec).

10. A first node of a first autonomous system (AS), the first node comprising:
a memory storing instructions;
a processor coupled to the memory, the processor configured to execute the instructions to cause the first node to:
receive, from a second node of a second AS, a first Border Gateway Protocol (BGP) update message comprising a flow specification (FlowSpec) AS authorization list indicating autonomous systems (ASes) that are authorized to issue a FlowSpec for a prefix of the second AS;
receive, from a third node of a third AS, a second BGP update message comprising a FlowSpec associated with the prefix of the second AS;
determine that the third AS is authorized to issue the FlowSpec when the FlowSpec AS authorization list includes the third AS;
determine whether the third AS is a closest neighboring AS to the first AS along a best-match unicast route for a destination prefix;
accept the FlowSpec when the third AS is the closest neighboring AS to the first AS along the best-match unicast route for the destination prefix and the third AS is authorized to issue the FlowSpec; and
perform a traffic flow action associated with the FlowSpec when the first node receives traffic that matches a set of traffic parameters specified by the FlowSpec.

11. The first node according to claim 10, wherein the processor is configured to execute the instructions to cause the first node to reject the FlowSpec when the FlowSpec AS authorization list does not include the third AS.

12. The first node of claim 10, wherein the processor is configured to execute the instructions to cause the first node to reject the FlowSpec when the third AS is not the closest neighboring AS to the first AS along the best-match unicast route for the destination prefix.

13. The first node of claim 10, wherein the FlowSpec AS authorization list is specified in a BGP FlowSpec trust list path attribute included in a path attributes portion of the first BGP update message.

14. The first node of claim 13, wherein the BGP FlowSpec trust list path attribute is an optional transitive BGP path attribute.

15. The first node of claim 13, wherein the BGP FlowSpec trust list path attribute is encoded using a Flowspec Trust List Type-Length-Value (TLV) encoding format, and wherein a value field of the Flowspec Trust List TLV specifies a list of autonomous systems (ASes) that are authorized to issue the FlowSpec.

16. The first node of claim 10, wherein determining whether the third AS is the closest neighboring AS to the first AS along the best-match unicast route for a destination prefix comprises determining whether the third AS is both in a left-most position of an AS_PATH attribute of a Flowspec route received via an External Border Gateway Protocol (eBGP) and in the left-most position of the AS_PATH attribute of the best-match unicast route for the destination prefix embedded in the Flowspec.

17. The first node of claim 10, wherein determining whether the third AS is the closest neighboring AS to the first AS along the best-match unicast route for the destination prefix comprises using a secured AS path list that is part of a routing table of the first node.

18. The first node according to claim 17, wherein the processor is configured to execute the instructions to cause the first node to obtain the secured AS path list using BGP security (BGPsec).

19. A non-transitory computer readable medium storing computer instructions, the computer instructions when executed by one or more processors of a node, cause the node to perform the steps of: receiving, from a first node of a first AS, a first BGP update message comprising a FlowSpec AS authorization list indicating autonomous systems (ASes) that are authorized to issue a FlowSpec for a prefix of the first AS;
receiving, from a second node of a second AS, a second BGP update message comprising a FlowSpec associated with the prefix of the first AS;
determining whether the FlowSpec AS authorization list includes the second AS; and
rejecting the FlowSpec when the FlowSpec AS authorization list does not include the second AS.

20. The non-transitory computer readable medium of claim 19, wherein the FlowSpec AS authorization list is specified in a BGP FlowSpec trust list path attribute included in a path attributes portion of the first BGP update message.
